(19) United States
(12) Patent Application Publication
(10) Pub. No.: US 2014/0202244 A1
(43) Pub. Date: Jul. 24, 2014

(54) Sensor Device and Method of Locking Sensor Device Components

(71) Applicant: HARCO LABORATORIES, INC., Branford, CT (US)

(72) Inventor: Igor Giterman, Woodbridge, CT (US)

(73) Assignee: HARCO LABORATORIES, INC., Branford, CT (US)

(21) Appl. No.: 13/745,510

(22) Filed: Jan. 18, 2013

(51) Int. Cl. G01D 11/24

(52) U.S. Cl. CPC G01D 11/245
USPC 73/431; 29/446

(57) ABSTRACT

The present invention refers to a sensor device and associated method of locking sensor device components. In some aspects of the invention, a housing assembly comprises a housing case for an exhaust gas temperature probe sensor device that can be used to lock one or more traversing studs and form an environmental seal using a plurality of insulators and a fastener locked onto the elongated body of each of the studs. The locking features of the housing case and locking part geometry can function to securely hold and align parts when the fastener is locked into place. The fastener can be a press fit bushing with a bushing weld.

### FIELD OF THE INVENTION

The present invention relates generally to sensor devices. More particularly, the present invention relates to an improved housing assembly of an exhaust gas temperature probe that is suitable especially in the automotive, industrial, aerospace, and like high demanding fields.

### BACKGROUND OF THE INVENTION

A variety of sensors are used in different everyday systems and fields. Accuracy and reliability of said sensors are often of upmost importance in many applications in which sensor data is to be relied upon either by a system or a user. Moreover, a number of fields can require special considerations depending on the application in order to sustain different environmental conditions and perform as needed.

Application specific sensor designs have been developed for specific high demanding fields including, for example, for the automotive, industrial, and aerospace applications. For example, in these fields, sensors are known to be placed in thermocouple harness systems such as probe sensor devices. While currently available probe devices can provide replacement advantages, easier installations and improved performance, the enclosing providing the environmental seal needed of the current probe designs is frequently compromised during anticipated harsh environment operation conditions and/or during troubleshooting and service thereby significantly decreasing their performance and durability.

Accordingly, it is desirable to provide an improved sensor device that comprises a housing assembly configured to sustain anticipated harsh environment operation conditions and/or troubleshooting and servicing while providing ease of installation, fixed stability, and a cost efficient reliable environmental seal.

### SUMMARY OF THE INVENTION

The foregoing needs are met, to a great extent, by the present invention, wherein in one aspect a cost efficient sensor device that includes a housing assembly capable of sustaining anticipated harsh environment operation conditions and/or troubleshooting and servicing without compromising the ease of installation, fixed stability, and its environmental seal.

In accordance with one aspect of the invention, a sensor housing assembly can be configured to provide a locking mechanism that can be significantly independent from its environmental seal. In some embodiments, the sensor housing assembly includes a housing case configured to secure one or more studs and insulating components thereto and provide an environmental seal for an enclosed environment and a sensor portion of one or more studs therein. The environmental seal can be secured, entirely or partially, using locking feature(s) on at least one side of the housing case and a securing fastener such as a press fit bushing. Furthermore, in some embodiments, the housing case's locking features along with the fastener may be configured to provide fixed stability by alignment of the locking features, thereby preventing rotation of the stud and increasing the strength and durability of the environmental seal.

In accordance with another aspect of the present invention, the environmental seal provided by the sensor housing assembly can include a mating feature with flat surface portion on a surface of the housing case, on the opposite side of the locking features included in the housing case, to position an insulating component and help align it perpendicularly to the body of the stud. The flat surface portion can provide for a more consistent assembly reducing the possibility of a stud, or insulating part, breaking or loosening thereby allowing moisture to penetrate the housing.

In accordance with still another embodiment aspect of the present invention, the sensor housing assembly can provide a strong and reliable environmental seal by aligning and locking a stud and insulating components to the housing case using locking features on one side of the housing case and a press fit bushing secured onto a portion of the stud on the opposite side of the housing case. This method of securing the studs and insulating components no longer relies on friction forces provided by the potting inside the housing case and the weakest part of the stud. The press fit bushing provides for stronger stability and alignment for the environmental seal, increasing the durability, even under demanding changes in pressure, temperature conditions, and/or troubleshooting and servicing.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a perspective view illustrating an exemplary exhaust gas temperature probe sensor (“EGT probe sensor) embodiment according to aspects of the invention.

FIG. 2 is an isometric cutaway and partially disassembled view of an exemplary locking housing assembly of the EGT probe sensor in FIG. 1.

FIG. 3 is a partial side view of a cross section of the locking features included in the housing case of housing assembly in FIG. 2.

FIG. 4 is a partial top view of a cross section of the locking features included in the housing case of housing assembly in FIG. 2.

FIG. 5 is an isometric cutaway and partially disassembled view of another exemplary locking housing assembly of an EGT probe sensor.

FIG. 6 is a partial side view of a cross section of the locking housing assembly cutaway view in FIG. 5.

FIG. 7 is a flowchart illustrating method steps that may be implemented in accordance with some embodiments of the present invention.

### DETAILED DESCRIPTION

The invention will now be described with reference to the drawing figures, in which like reference numerals refer to like parts throughout. Embodiments of the present invention provide a strong and reliable environmental seal that does not solely rely on friction forces provided by potting inside the housing case and the weakest part of a stud. In some aspects of the invention, securing a component along a section of the stud and aligning parts to locking features provides for significantly independent securing means for the environmental seal. Said independent securing means can prevent rotation that often causes damages to the seal and allows for a stud that does not require through holes and as a result may be stronger and more durable than other systems.

Sensor devices, including but not limited to exhaust gas temperature probe sensors (“EGT probe sensor) rely on the environmental seal provided by a housing case and its associated parts. These types of sensors are often used in engine systems in fields including in aerospace, industrial and automotive fields. In the aerospace field for example, aircraft's engines systems and/or the pilots may rely on EGT probe sensor readings for the operation and servicing of the engine systems. Damaged environmental seals of EGT probe sensor(s) often occur due to numerous factors causing bad readings which can result in the consequences caused by the engine system malfunctioning and/or unnecessary servicing.

Environmental seals provided by the housing case and its parts are compromised by its weakest component or a component's weakest attaching part and/or method. As a result, it is desired that the weakest component or component's attaching part and/or method be capable of sustaining anticipated changes such as changes in pressure, temperature, structural changes, and the like, caused during operation of the engine system and/or troubleshooting and service.

A cost effective solution for the realized weakest component and attaching parts of sensor devices and associated method for providing a significantly improved environmental seal is realized by some embodiments in accordance with the invention. The sensor device can include an independent means to attach and fix one or more stud(s) to the housing case, alternatively or in addition, to the force provided by the potting inside the housing case and the friction forces, being the sole means to secure stud(s) and the associated components in existing sensor devises.

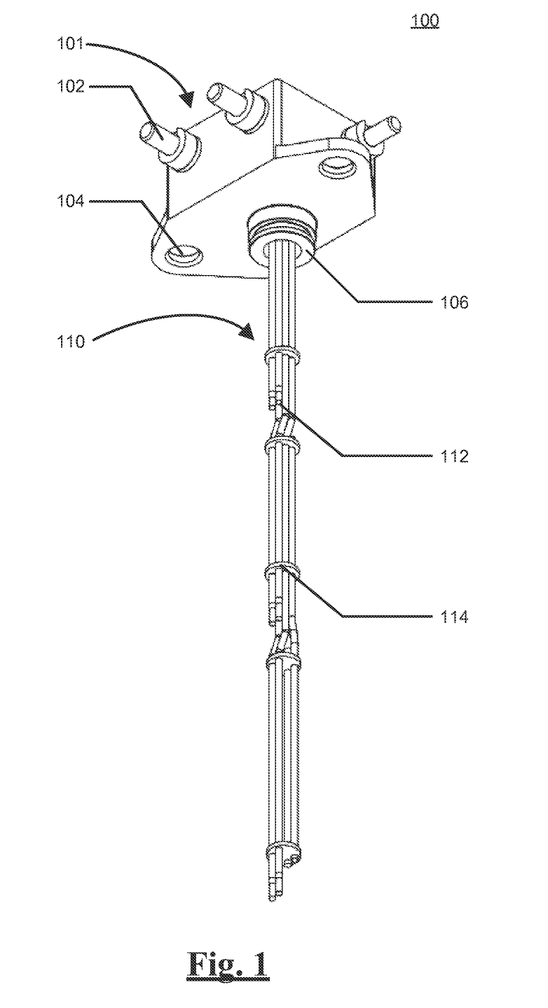

An exemplary sensor device is illustrated in FIG. 1. In particular, FIG. 1 is a perspective view illustrating an exemplary EGT probe sensor 100 embodiment according to aspects of the invention. The exemplary EGT probe sensor 100 including an elongated sensor body 110 leading to a housing assembly 101 configured to receive one or more stud(s) 102.

In some embodiments, the housing assembly 101 can be installed to engine systems using securing means such as a mating part (not shown) or one or more holes 104 to secure a part therein thereby securing the housing assembly 101 to an engine system (not shown). For example, the housing assembly 101 may be secured to the outside of an enclosure of the exhaust in of an engine system allowing the elongated sensor body 110 to penetrate the enclosure without disturbing the engine system's environment using a coupling part and/or seal gasket 106 that can reside in proximity to the opening of the enclosure (not shown) and allow the elongated sensor body 110 including, for example, one or more sensors 112, alignment plates 114, and the like, to reside and take readings inside the exhaust enclosure as may be desired. The one or more sensors 112 may include, for example, temperature sensors, pressure sensors, chemical sensors, current sensors, flow sensors, and the like.

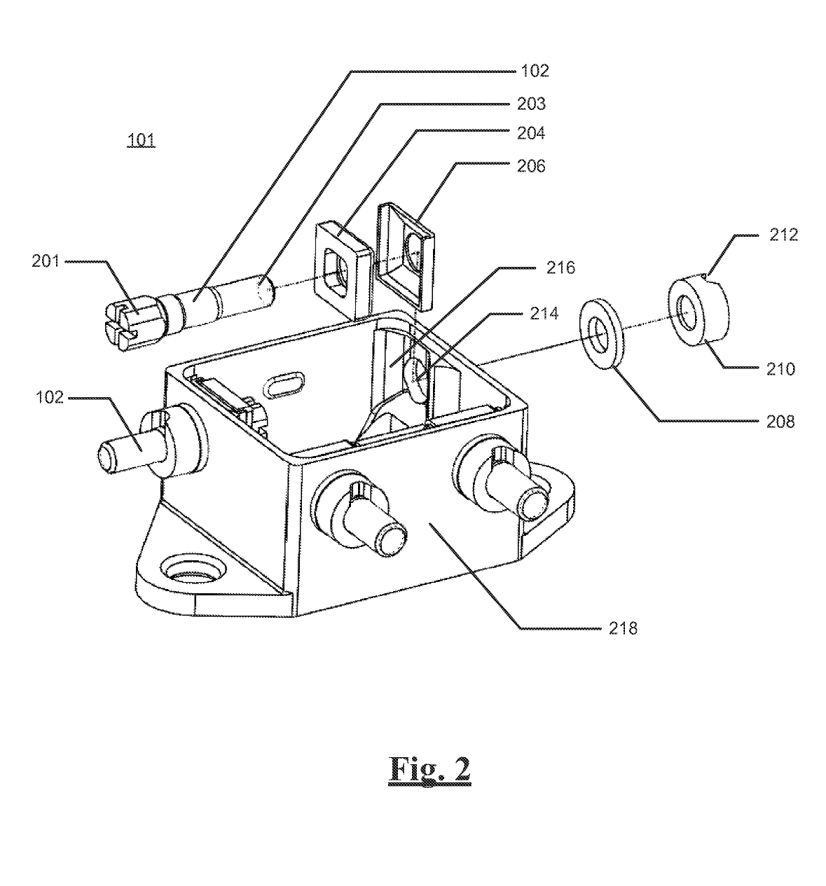

FIG. 2 is an isometric cutaway and partially disassembled view of an exemplary housing assembly 101 of the EGT probe sensor 100 in FIG. 1. In particular, FIG. 2 depicts a housing assembly 101 with associated exemplary components according to some aspects of the present invention. In some embodiments, a new or replacement stud 102 may secured to a housing case 218 during assembly and/or troubleshooting and/or service of an EGT probe sensor 100. To complete assembly and/or repair, all studs 102 can secured, to the housing case 218 providing an environmental seal against the outside atmosphere.

According to some aspects of the present invention, a narrow end 203 of a stud 102 can be inserted into locking plate 204 and internal insulator 206. Subsequently, said narrow end 203 of the stud 102 may be inserted through an opening 214 of the housing case 218. Neighboring the opening 214 of the housing case 218, the geometry of corresponding locking features 216 can mate with the locking plate 204 thereby helping in the alignment and rotationally affixing of the stud 102 after it is inserted.

Subsequent to said narrow end 203 of the stud 102 having been inserted through opening 214, an insulating washer 208 can be inserted into the same narrow end 203 of the stud 102. A press fit bushing 210 with a bushing weld 212 may be used to press fit and secure the inserted parts firmly to the housing case 218. The bushing weld 212 may be used to help the press fit bushing 210 retain the environmental seal compression and keep the stud 102 locked in place.

The environmental seal is in part created by the insulating components which may be, for example, conventionally used mica washer insulators, or any other rigid structure of a non-conductive composition or a metal with a non-conductive coating that can prevent electrical insulation. Rigid and non-conductive materials can include polymers, ceramic compositions, or the like. Suitable polymers include but are not limited to rigid plastics, rubbers, acrylics, nylons, polystyrenes, polyvinylchlorides, polycarbonates, polyurethanes, polyethylenes, polypropylenes, polyamides, polyethers, polyesters, polyolefins, polyacrylates, polyisoprenes, fluoropolymers, combinations thereof or the like.

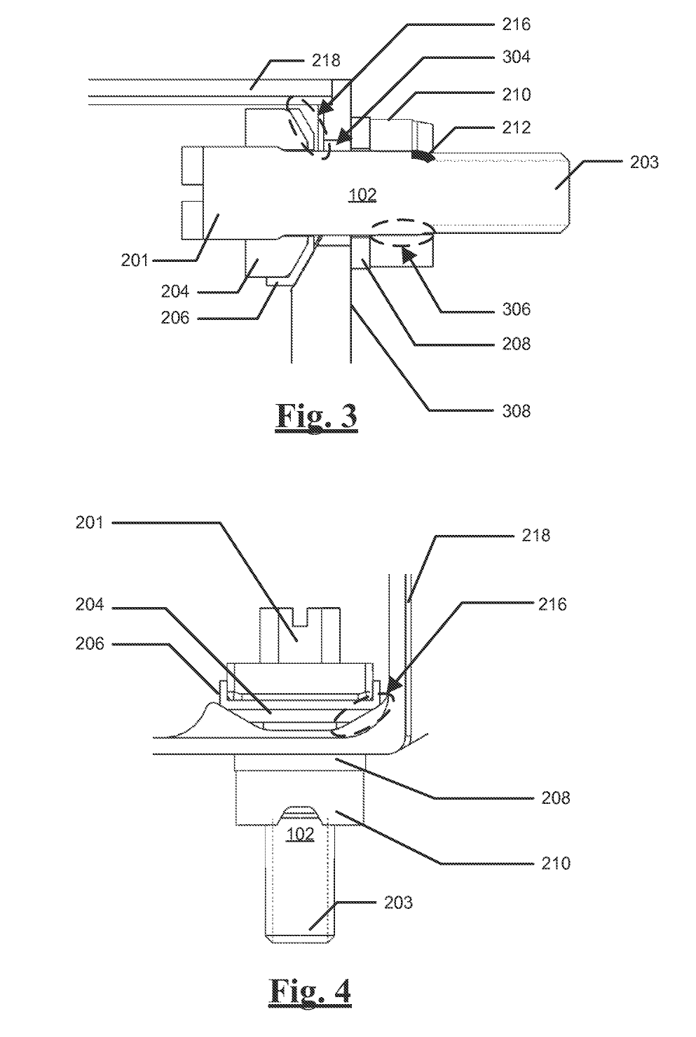

FIG. 3 is a partial side view of a cross section of the housing assembly 101 cutaway view in FIG. 2. In particular, FIG. 3 depicts exemplary locking features 216 capable of aligning components and affixing components according to some aspects of the present invention. Stud 102 is shown confined to the housing case 218 by the stud's restricting end 201 with locking plate 204 and internal insulator 206 pressed towards the locking features 216 of the housing case 218, and insulating washer 208 pressed towards a flat surface 308 of the housing case 218 by fastener 210. The fastener 210 may be a press fit bushing 210 and include a bushing weld 212 used to firmly hold and align pressed together components along with the geometry of the locking features 216 to thereby prevent rotation and/or movement.

According to some inventive aspects, the air gaps 304 between the housing case 218 and the stud 102 used along with the internal insulator 206 and insulating washer 208 to provide an electrical gap between the stud 102 and/or press fit bushing 210 and the housing case 218 may not cause movement and disadjustment of the components due to the improved locking mechanism.

In essence, the press fit bushing 210 may hold in place the components with an interference fit that can allow stud 102 to pass through and be aligned and held firmly while providing a moisture proof seal that prevents moisture egress into the housing case 218 around the stud 102. Although the fastener 210 is described in the exemplary embodiments as a press fit bushing 210, other suitable fastening parts may be included that along with the locking features 216 can axially align and hold together part components. For example, the fastener 210 may additionally or alternatively include a clamp, clip, bolt, and the like, that would not rely on the force provided by the potting (not shown) inside the housing case 218 for the seal.

FIG. 4 is a partial top view cross section of the locking features 216 included in the housing case 218 of housing assembly 101 in FIG. 2. In particular, FIG. 4 depicts exemplary locking components according to some aspects of the present invention. Locking components can include the locking plate 204 which, along with the locking features 216 and fastener 210, can align, lock, and/or prevent rotation holding into place the stud 102, internal insulator 206, and insulating washer 208 onto the housing case 218. Rotation can be prevented both by friction between adjacent parts and due to the interference 402 between the geometry of the locking features 216 and the locking plate 204. The locking features 216 and the locking plate 204 can couple with each other once when the elements are pressed together and/or locked by the press fit bushing 210.

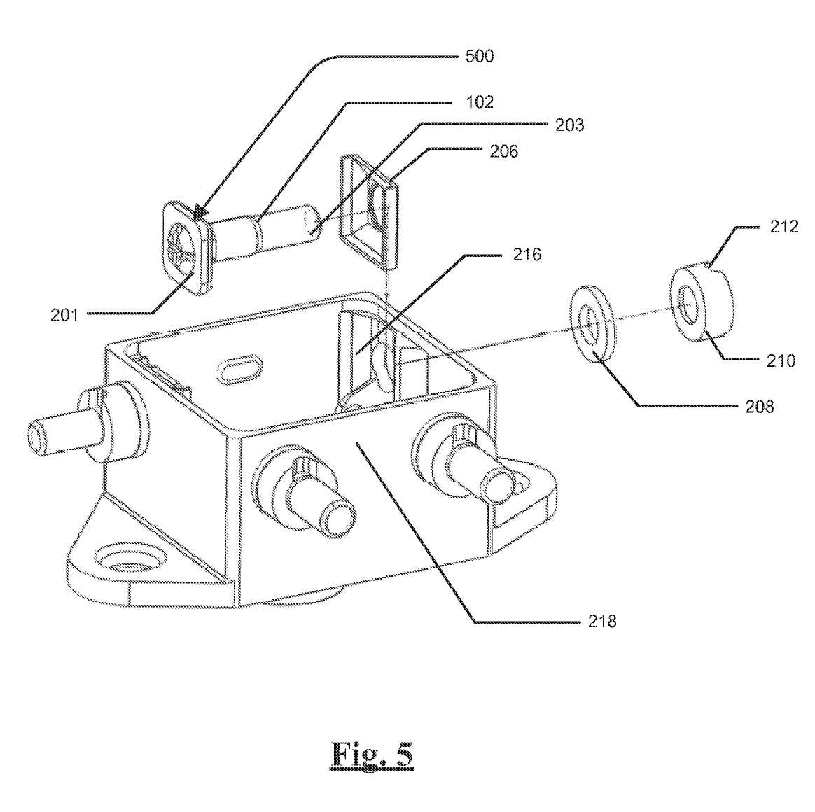

FIG. 5 is a isometric cutaway and partially disassembled view of another exemplary housing assembly 101 of the EGT probe sensor. In particular, FIG. 5 depicts alternative exemplary locking stud 102 according to some aspects of some embodiments in accordance with the present invention. In some embodiments according to aspects of the present invention, a restricting end 201 of a stud 102 can include a locking geometry 500 that can connect to a corresponding internal insulator 206 and locking features 216. Neighboring the opening 214 of the housing case 218, the geometry of corresponding locking features 216 can couple with the restricting end 201 of stud 102 including a locking geometry 500 to thereby help align and firmly hold the stud 102 and the pressed together internal insulator 206 and insulating washer 208, after it is inserted through opening 214, and pressed together by the press fit bushing 210. The press fit bushing 210 can include a bushing weld 212 used to press fit and secure the inserted parts firmly to the housing case 218 to retain the seal compression and keep the stud 102 locked in place.

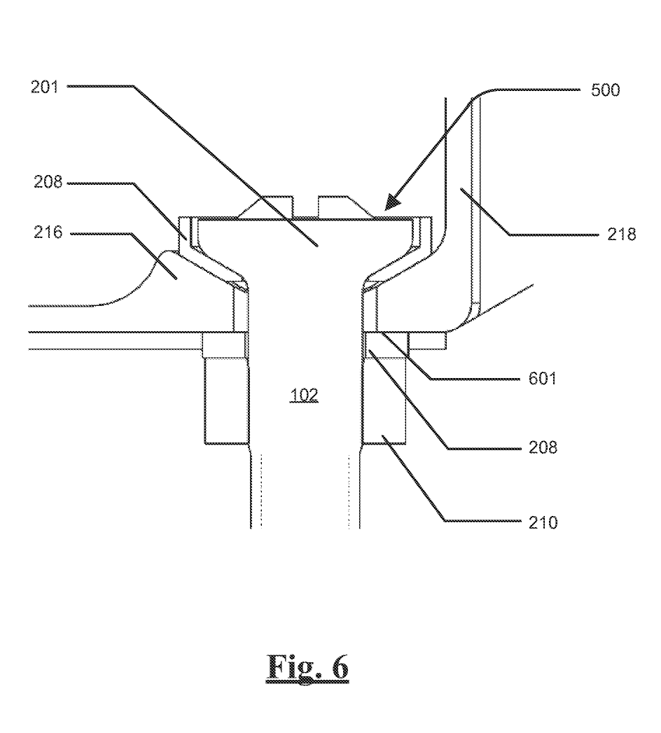

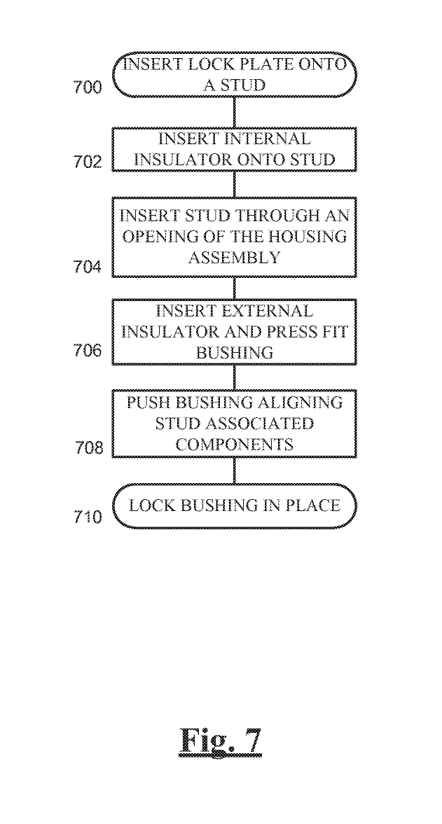

FIG. 6 is a partial side view of a cross section of the housing assembly 101 cutaway view in FIG. 5. In particular, FIG. 6 depicts a side view cross section of the alternative exemplary stud 102 with its restricting end 201 including a locking geometry 500 according to some additional aspects of the invention. In the present exemplary embodiment, housing case 218 includes a mating flat surface 601 for at least a portion of insulating washer 208 to fit in. In some embodiments, this may increase the effectiveness of the environmental seal by further protecting and aligning parts components in a similar manner as described in previous embodiments. For example, stud 102 restricting end 201 including the locking geometry 500 corresponding to the geometry of the internal insulator 206 and the locking features 216 can be centered and firmly restrained in its aligned position using the press fit bushing 210. Moreover using this housing case 218, the insulating washer 208 can be centrally aligned once it is mated onto the flat surface 601 of the housing case 218 thereby subjecting the insulating washer 208 only to evenly distributed axial force.

FIG. 7 is a flowchart illustrating method steps that may be implemented in accordance with some embodiments of the present invention. At 700, in some embodiments where a locking plate 204 is used it can be inserted through a narrow end of a stud 203. Alternatively, in some embodiments, a locking geometry can be incorporated into the restricting end 102 of the stud 201 and therefore the locking plate 204 may not be needed. At 702, in a similar manner, an internal insulator 206 can be inserted.

At 704, said narrow end 203 of the stud 102 can be inserted through a housing case 218 opening 214 thereby restraining the locking plate 204 and internal insulator 206 between the restricting end 201 of the stud 102 and the housing locking features 216. At 706, an external insulator can be inserted followed by a press fit bushing 210. At 708, by pressing the press fit bushing 210 towards the housing case 218, the geometry of the locking components can function to align centrally in relation to the stud 102 and perpendicularly in relation to the housing case's 218 opening 214. Subsequently at 720, the press fit bushing 210 may be locked into place fixing components thereto and creating an environmental seal for the housing assembly 101.

Although specific exemplary embodiments of the invention have been described, internal and external components and configurations may be implemented in reverse to provide the same benefits provided by the inventive aspects described. In addition, it will be appreciated by one skilled in the art that other related items can be incorporated and used along with embodiments derived from the present invention.

The many features and advantages of the invention are apparent from the detailed specification, and thus, it is intended by the appended claims to case all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A housing assembly of a sensor device, comprising:
a housing case configured to receive a stud with an elongated body and a restricting end, wherein the elongated body contains a locking plate and a plurality of insulating parts;
locking features in proximity to an opening on a surface of the housing case and the locking plate constraining the restricting end of the stud; and
a fastener configured with the restricting end of the stud to hold therebetween the locking plate and insulating parts and lock them onto the housing case.

2. The housing assembly of a sensor device of claim 1, wherein the fastener is a press fit bushing.

3. The housing assembly of a sensor device of claim 2, wherein the press fit bushing comprises a weld used to lock the press fit bushing onto the stud.

4. The housing assembly of a sensor device of claim 1, wherein the shapes of the locking plate and locking features on the housing case couple to centrally align the locked stud.

5. The housing assembly of a sensor device of claim 1, wherein the body of the stud is generally a solid elongated structure with a restricting end.

6. The housing assembly of a sensor device of claim 5, wherein at least a portion of the elongated body of the stud is threaded.

7. The housing assembly of a sensor device of claim 1, wherein the housing assembly provides an environmental seal once the stud is locked into place.

8. The housing assembly of a sensor device of claim 1, wherein said plurality of insulating parts include an insulating washer positioned on a mating portion on a surface of the housing case.

9. A housing assembly of a sensor device, comprising:
a housing case configured to receive a stud with an elongated body and a restricting end including a locking geometry, wherein the elongated body contains a plurality of insulating parts;
locking features in proximity to an opening on a surface of the housing case constraining the restricting end of the stud; and
a fastener configured with the restricting end of the stud to hold therebetween the insulating parts and lock them onto the housing case.

10. The housing assembly of a sensor device of claim 9, wherein the fastener is a press fit bushing.

11. The housing assembly of a sensor device of claim 10, wherein the press fit bushing comprises a weld used to lock press fit bushing onto the body of the stud.

12. The housing assembly of a sensor device of claim 9, wherein the locking geometry of the restricting end of the stud and locking features on the housing case couple to centrally align the locked stud.

13. The housing assembly of a sensor device of claim 9, wherein the stud has a solid elongated cylindrical structure.

14. The housing assembly of a sensor device of claim 9, wherein the housing assembly provides an environmental seal once the stud is locked into place.

15. The housing assembly of a sensor device of claim 9, wherein said plurality of insulator parts includes an insulator washer positioned on a mating portion on the surface of the housing case.

16. A method of securing one or more studs onto a probe housing assembly comprising:
positioning locking plate in proximity to the elongated body portion of a stud onto locking features on a surface of a housing case in proximity to a stud opening;
positioning a press fit bushing on a portion of the elongated body of the stud; and
locking the stud, a plurality of insulating parts and a portion of the housing case around the stud opening in between the restraining end of the stud and the press fit bushing.

17. The method of claim 16, additionally comprising:
aligning the stud centrally inside the stud opening upon pressing together the press fit bushing towards and the restraining end of the stud.

18. The method of claim 16, additionally comprising:
using a bushing weld on the press fit bushing to secure the parts firmly forming an environmental seal.

19. The method of claim 16, wherein the locking features contiguous to the elongated body of the stud are included on a locking plate constrained by a restricting end of the stud.

20. The method of claim 16, wherein the locking features contiguous to the elongated body of the stud is part of a restricting end of the stud.
